(19) United States
(12) Patent Application Publication
(10) Pub. No.: US 2017/0244879 A1
(43) Pub. Date: Aug. 24, 2017

(54) Automatic Switching Multi-Video

(71) Applicant: Richard Dikran Bezjian, Watertown, MA (US)

(72) Inventor: Richard Dikran Bezjian, Watertown, MA (US)

(21) Appl. No.: 15/046,466

(22) Filed: Feb. 18, 2016

(51) Int. Cl. H04N 5/225; H04N 5/77; H04N 5/232

(52) U.S. Cl. CPC H04N 5/2259; H04N 5/2258; H04N 5/23216; H04N 5/772

(57) ABSTRACT

A function on video recording devices that enable the user to automatically switch video recording from a front camera to a back or other camera without stopping the video or rotating the recording device, eliminating the need for separate persons acting as reporter and cameraman, eliminating the need to merge multiple video clips to make a complete video, and eliminating undesired content occurring while a device is rotated from one target to another.

### CROSS REFERENCE TO RELATED APPLICATIONS

Not applicable

### STATEMENT REGARDING FEDERALLY SPONSORED RESEARCH OR DEVELOPMENT

Not applicable

### NAMES OF PARTIES TO JOINT RESEARCH AGREEMENT

Not applicable

### SEQUENCE LISTING

Not applicable

### STATEMENT REGARDING PRIOR DISCLOSURES

Not applicable

### BACKGROUND OF INVENTION

The present invention is in the technical field of video content. More particularly, this invention relates to the technical field of shooting and recording videos (with audio) with a mobile or other video recording device. It includes the process where a predefined or automated method is used to record a certain amount of time in one direction and followed with another period of time recording in other directions. Within the scope of this invention the recording device may be a single unit, yet have front and back microphone or camera and even more cameras pointing in different directions, and when the recording begins, it can record via the camera and microphone on the front of the device, and after a certain predefined time may automatically switch to the back or any other camera and microphone and record with those.

Video and audio recording has been used to capture and document events. Expensive and hard to manage devices are often used by several people involved to do the recording. In recent years, more and more devices have been made and shipped and they include the popular handsets, smartphones or tablets. They may record easily at the touch of few options on the screen. They include front and back cameras, and the user can use either the front camera, then tap the button to switch control to the back and record with the back camera.

In current methods of operating recording sessions at least 2 people are needed to achieve the same result. For example a reporter and the cameraman. While the reporter speaks the cameraman points the camera at the reporter and records the reporter's introduction, then the cameraman redirects the camera to another direction and records another scene the reporter is discussing or presenting.

This invention unifies the two processes and eliminates the need for more than one person.

### BRIEF SUMMARY OF INVENTION

This invention is the method of automating or predefining the tasks of different directional recordings into one simple recording sequence, thereby with one person and one device the recording can begin with the front camera of the device and then automatically switch control to the back camera of the same device and continue recording with the back camera, or any other camera the user determines.

Most recordings have the need to record different views from different directions, then combining the different directional recordings into one unified stream. For example recording of an introduction or a beginning part can be recorded first. This can be done with the use of the front camera. Soon after such introduction the person has to physically rotate the camera to the other side to continue to record the other side of the scene, yet this records unwanted areas between the front and back directions, and is not professional and is not desirable.

The user can also stop the front camera recording and switch control to the back camera and start recording with the back camera. This is not very efficient and it creates two separate video clips which then need to be merged.

This invention is the method by which by selecting a Switching Video mode of the device, the front camera begins to record for a predefined length of time and then the device automatically switches control to the back camera and the recording continues with the back camera. Other options for determining when the device switches from one camera to another include a hard button trigger, or a soft trigger such as a voice command.

### BRIEF DESCRIPTION OF THE SEVERAL VIEWS OF THE DRAWING

The drawings use a mobile device as the example of a recording device using the Automatic Switching Multi-Video.

FIG. 1 depicts: 1. An icon, the pressing of which results in the activation of the front camera; 2. the image appearing through the activated front camera; and 3. the hard button that, when pressed and held, begins recording with the front camera for a pre-set duration, after which it automatically switches to the back camera, continuing to record until the hard button is released.

FIG. 2 depicts: 4. the image appearing through the activated front camera; 5 the hard button that, when pressed and held, begins recording with the front camera for a pre-set duration; and 6. the numeral ‘5’ denoting the pre-set duration of recording through the front camera before the recording device automatically switches to the back camera.

FIG. 3 depicts: 7. The image appearing through the back camera after switching; 8. The hard button that the user continues to hold until they want to stop recording; and 9. the number ‘15’ denoting the pre-set maximum duration for continuing to record through back camera.

FIG. 4 depicts: 10, 11, 12, & 13. The scenes being currently captured by four different cameras embedded in the device, as displayed on the screen of the mobile device, enabling the user to know what scene can be recorded with whichever camera he or she selects to activate.

FIG. 5 depicts a flow chart for the method of using the auto-switching video” 14. First, the user presses the icon to activate the Auto-Switching mode; 15. Next, the user sets the duration for recording through each camera; 16. Next, the user presses and holds the record button; and 17. Next, the user continues to press the record button until either the timer reaches 0 or the user releases the button to end recording.

FIG. 6 depicts the simultaneous display on the device's screen of the scenes being captured by both front and back cameras for simul-recording function, showing two examples of how the user may choose to display on the screen the scenes being captured by each camera. The top view shows both cameras' currently captured scenes displayed in equal size: 18. The view through the front camera; 19. The view through the back camera; 20. The record button that would simultaneously record through both front and back camera. The bottom view shows both cameras' currently captured scenes displayed in unequal size: 21 The view through the front camera in a small-size window; 22. The view through the back camera in a larger-size window; 23. The record button that would simultaneously record through both front and back camera.

FIG. 7, top view, textually depicts a configuration where multiple microphones are connected to corresponding camera, such that 24. The front camera is connected to 25. A microphone configured to record audio in conjunction with the front camera, and 26. The back camera is connected to 27. A microphone configured to record audio in conjunction with the back camera. FIG. 7, bottom view, textually depicts a configuration where a single microphone is connected to both front and back camera.

### DETAILED DESCRIPTION OF THE INVENTION

This invention is the method of switching from one camera and microphone to another to take different directional recordings from different cameras and create one simple recording sequence, thereby with one person and one device the recording can begin with the front camera and then automatically switch control to the back camera or any other camera embedded in the device and continue recording with the chosen camera.

During the recording sessions of current technologies, usually 2 or more people are needed to achieve the same result. The Cameraman uses the camera to record the video and audio of the reporter first, and after the reporter's introduction the cameraman points the camera to another direction and records the scene in question. Even by using two people in such a case, the cameraman has to stop and reorient the camera and restart the recording in the next direction, or if the cameraman continues recording while changing direction then the recording session may capture other unwanted scenes between the Reporter scene and the final scene.

This invention automates this process, and enables only one person to both act as the reporter and the cameraman by using the same one device equipped with front and back cameras, and other directions, and utilizing this invention of Automatic Video switching. This produces, easy, multi-direction recording and it produces a merged sequence of recordings in one step.

This invention includes several methods of recording for the Switching Video. The additional methods include: (i) Preset time for Front camera, (ii) Hard tap/Trigger to switch cameras, (iii) Soft embedded trigger to switch cameras. (iv) Front-Back-Front Camera method, (v) Multi-Camera method, (vi) Simul-record method, and (vii) sending content to other connected devices.

(i) Preset time or Front Camera method provides the options for the user to start the recording with the front camera, where the time allocated for the front camera to record the introduction part pointed at the person is preset to a certain defined length of time, such as 5 or 15 or 30 seconds or any length of time selected by the cameraman. When the person starts to record, as soon as the preset time is reached the device automatically switches controls to the back camera and continues recording with the back camera until the user stops the recoding.

Buttons on such devices can be mechanical or motion sensitive where the user must press or depress the button to start or stop an action of recording. In recent years, touch sensitive screen interface has been built, where the simple tap on an icon or an area on the screen will trigger and action. Some of the common ones are the Apple i-phone or Android Operating system-driven smart phone devices. These devices are loaded with specific software that show buttons and options on the screen, and the user simply taps on any icon on the screen to activate its function. Such i-phone or Android smart phone devices have also been built with two cameras, one on the front side and the other on the back side of the device. While cameras can capture video, a corresponding microphone captures the audio of the same video event. The device can be equipped with one microphone that captures the sounds from any direction, or can have one microphone on the front side that records the audio of the video recording being captured by the front camera, and another microphone on the back side of the phone that records the audio of the video recording being captured by the back camera. In all cases, the camera device, through its hardware and software combines the video (from the camera) and audio (from the microphone) to provide a unified video recording that includes video and its sound. In all cases where we refer to camera recording we refer to both the video and its corresponding audio recording done together.

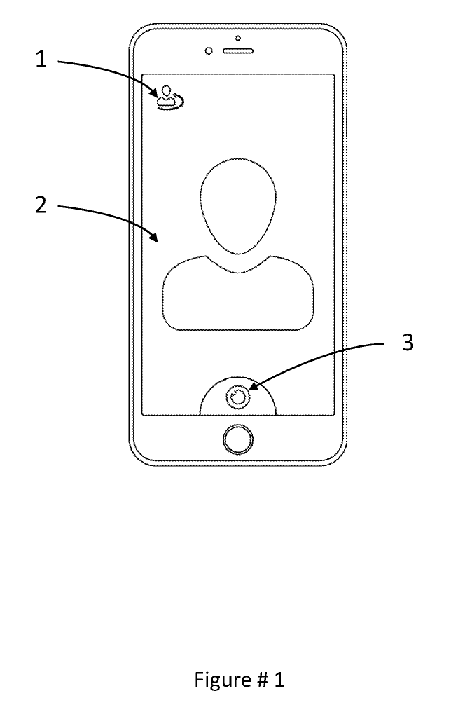

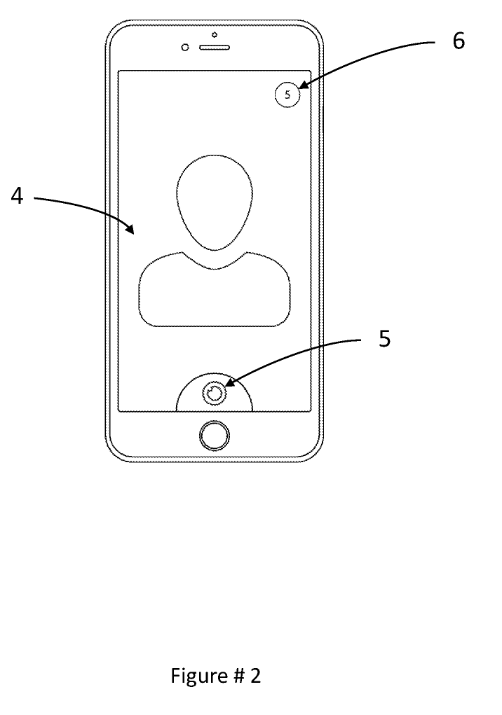

FIG. 1-1 shows the icon that the mobile device user taps in order to activate the front camera. FIG. 1-2 shows the live image being captured by the front camera. FIG. 1-3 shows the button the user must tap in order to begin the recording. The user then keeps their finger tapped on the said button to continue recording. Recording will stop when the user un-taps or removes their finger from that button. The same effect can be achieved by the use of another program application loaded in the same device, where the recording software application does not require the user to tap and hold on the button to continue recording, but rather the simple gesture of tapping once on the button begins the recording, and then tapping it again could stop the recording.

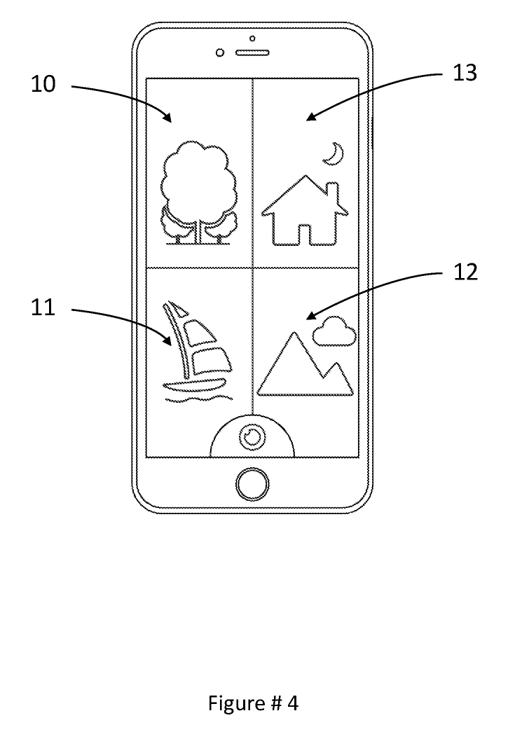

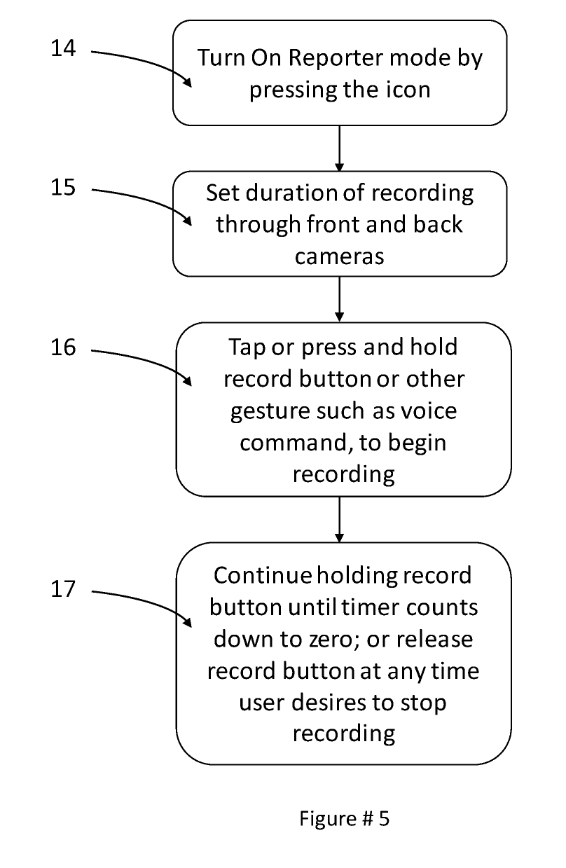

FIG. 2-4 again shows the image being recorded; FIG. 2-5 again shows the button to tap and hold to record. FIG. 2-6 shows the timer that the user pre-sets for the duration of the front camera to record (in the case of the illustration, 5 seconds). As the user taps the recording button, the timer counts down to 0, after which the recording by the device automatically switches to the back camera and begins recording the content being captured through the back camera view.

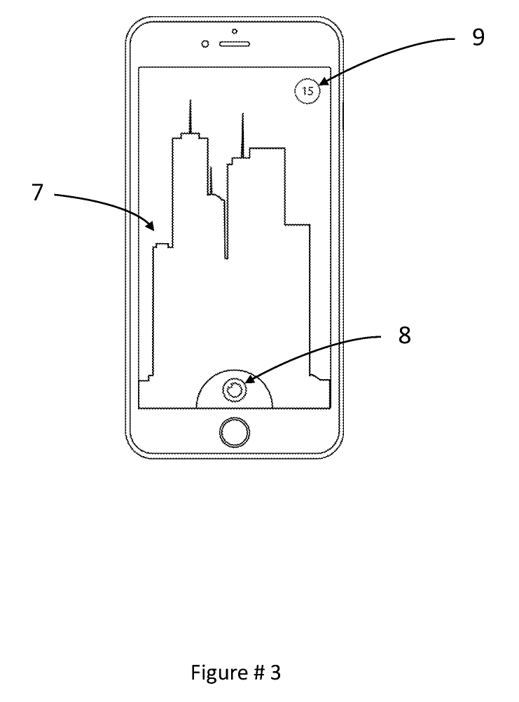

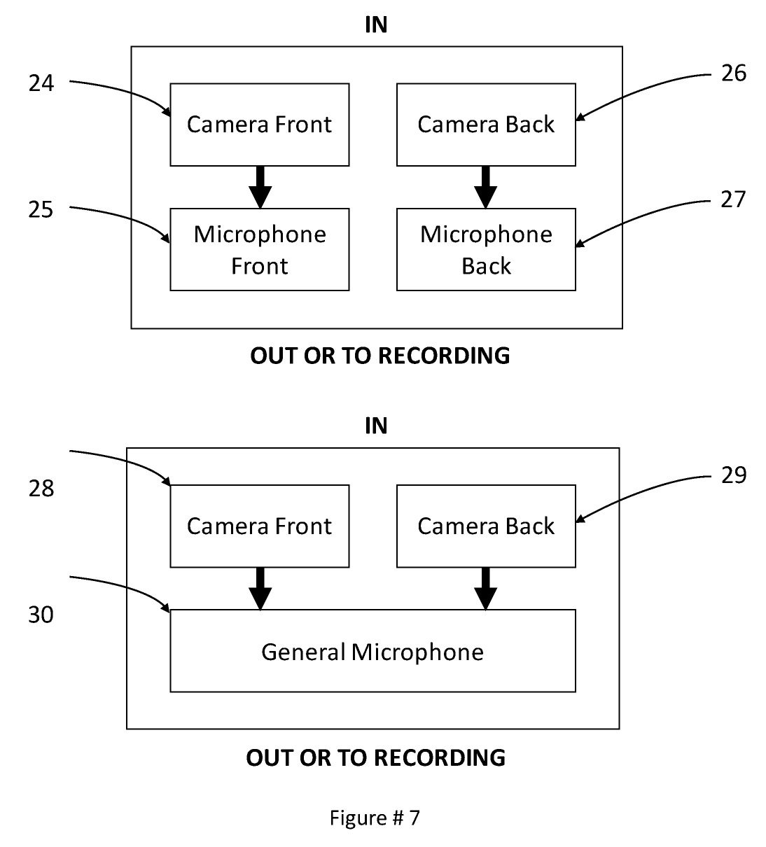

FIG. 3-7 shows the view through the back camera after the device has switched from the front to the back. At this point, the recording direction has gone from front to back camera. FIG. 3-8 shows the recording button that the user continues to hold while the back camera continues to record. FIG. 3-9 shows the pre-set duration the user has set for the back camera to record (in the case of the illustration, 15 seconds). As the user continues to record, the timer counts down to 0, after which the recording ends. The user can also simply remove their finger from the recording button to end the recording at any time. The same effect is also achieved by having the device start the recording when the user taps on the record button, the recording will record the first 5 seconds via the front camera, then will switch control to the back camera and continue recording on the back camera, until the user taps the record button again which will stop the recording.

(ii) The hard tap/trigger method to switch cameras provides the options where there is no preset time for the introduction part of the recording being done by the front camera or other cameras. The user begins recording with the front camera by tapping the recording button (depicted in FIG. 1-3), and when the user wishes to switch to the back camera, he or she taps the button again, causing the video to automatically begin recording through the back camera.

(iii) Soft embedded trigger to switch cameras method provides an embedded soft trigger to switch cameras. For example this can be a unique or predefined word or a sound or a tonality that the person may say, at which point the program running the video switching will detect this and switch recording to the back camera. An example of this may be the words “and here it is”. The user begins recoding through the front camera by tapping the recoding button (FIG. 1-3), and as soon as the person says the trigger words the switching video system detects this and switches controls to the back camera.

(iv) Front-Back-Front Camera method includes a further elaboration of the basic Front and Back camera method, where recording may start with the Front Camera, then switch to the Back camera, and then for conclusion switch to the Front camera again. This can be accomplished through any of the three methods for switching: pre-set time, hard tap/trigger, or soft embedded trigger (voice).

(v) Multi-Camera method includes the option that the device may have more than the two cameras, such as it may have four cameras, one on the front of the device, and three others one pointing to the right the other to the back and the other to the left. Using the same above basic methods of operating the recording, the user can control which cameras need to be activated for recording and in what sequence, using any method: pre-set times, hard tap trigger, soft (voice) trigger.

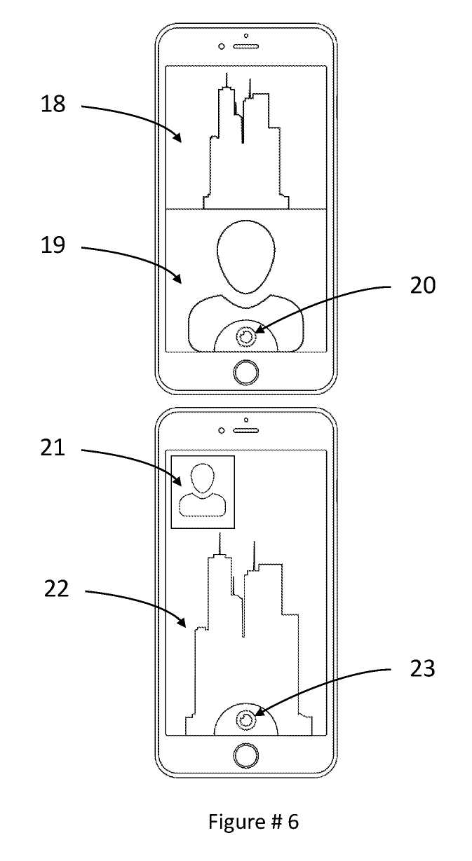

(vi) Simul-recoding method includes the option that the device will record with the front and back cameras where some part of the screen shows the recording of one camera and the other part shows the recording of the other camera. Such display organization can be automatically preset by the software of the device or selected by the user, to have equal screen area on the screen such as in the top view of FIG. 6, or smaller and larger screen areas such as the bottom view in FIG. 6. When the cameraman taps the camera switch button or taps the icon, the screen rearranges the video into their appropriate positions.

(vii) The method of capturing the camera and microphone switching video contents and instead of recording them to rather send them via mobile, wired, WiFi or wireless connectivity to other devices or to connected data storage services.

What is claimed is:

1. I claim a method for a video recording device to automatically switch directions from one view (such as front camera) to another view among multiple directions available from multiple cameras embedded in, attached to, or networked with the central device.

2. I claim a method, based on claim 1, for switching direction of a video recording device by pre-setting time for one camera such as the front camera, where the time allocated for the front camera is pre-set to a certain defined length of time, such as 5 or 15 or 30 seconds, after which pre-set time is reached the device automatically switches controls to another camera as pre-determined and continues recording until the user stops the recording.

3. I claim a method, based on claim 1, for switching directions of a video recording device via a hard tap/trigger to switch cameras, where there is no pre-set time for the initial camera or other cameras.

4. I claim a method, based on claim 1, for switching directions of a video recording device via a soft embedded trigger to switch cameras, such as a unique or pre-defined word or a sound or a tonality that the person may say (such as “go to back camera”), at which point the program running the video switching will detect this and switch recording to another camera.

5. I claim a method, based on claim 2, 3 or 4, further elaborating on the basic front and back camera method, whereby recording may start with the one camera such as the front camera, then switch to another camera, and then switch as many times as the user determines.

6. I claim a method, based on claim 2, 3 or 4, whereby recording can be done by a device with multiple cameras (such as one on the front of the device, one pointing to the right, one pointing to the back and one pointing to the left).

7. I claim a method for seeing on the screen of the mobile device the currently-captured scenes from multiple cameras embedded in or as part of one device and simultaneously recording multiple videos coming from more than one camera.

8. I claim a method for one or more devices using auto-switching video to send content its cameras are capturing to other devices or connected data storage services via WiFi or other connectivity.
